(19) United States
(12) Patent Application Publication
(10) Pub. No.: US 2017/0315256 A1
(43) Pub. Date: Nov. 2, 2017

(54) PROBE FOR ANALYZING THE CHARACTERISTICS OF THE MEDIUM SURROUNDING AN UNSLEEVED BOREHOLE

(71) Applicant: GEO ENERGY, GARENNES SUR EURE (FR)

(72) Inventor: Jean-Pierre MARTIN, GARENNES SUR EURE (FR)

(21) Appl. No.: 15/582,249

(22) Filed: Apr. 28, 2017

(30) Foreign Application Priority Data
Apr. 28, 2016 (FR) 16/53837

(51) Int. Cl. G01V 3/26; E21B 47/00

(52) U.S. Cl. CPC G01V 3/26; E21B 47/00

(57) ABSTRACT

A probe for analyzing the characteristics of the medium surrounding an unsleeved borehole including an elongated magnet; a ring of first magnetometers surrounding a substantially central portion of the magnet; second magnetometers connected to the magnet and arranged at a distance therefrom which is sufficient for the influence of the magnet field not to be perceptible; and means for processing the signals from the first and second magnetometers.

### CROSS-REFERENCE TO RELATED APPLICATIONS

This application claims the priority benefit of French patent application number 16/53837, filed on Apr. 28, 2016, the content of which is hereby incorporated by reference in its entirety to the maximum extent allowable by law.

### BACKGROUND

The present disclosure relates to crude oil exploration and more particularly to the analysis of the characteristics of a medium surrounding an unsleeved borehole.

### State of the Art

One of the steps of crude oil exploration comprises drilling unsleeved boreholes or open holes. The holes are filled with a drilling mud. It is desired to create an image of the medium surrounding the hole walls to analyze the succession of geological strata, their nature, their inclination, the direction of this inclination.

It is known to create an electric image of the medium surrounding the walls of an open hole in the case where the drilling mud is based on highly conductive salt water. To achieve this, a probe having electric current circulate in the hole wall is used, which enables to measure the electric resistance of the medium surrounding the hole walls and to characterize the medium.

However, for a number of years, non-conductive oil-based drilling muds have tended to be used. The above electrical measurement method can then no longer apply.

It is thus here provided to characterize the medium surrounding an open hole by magnetic means rather than by electric means.

### SUMMARY

Thus, an embodiment provides a probe for analyzing the characteristics of the medium surrounding an unsleeved borehole comprising an elongated magnet; a ring of first magnetometers surrounding a substantially central portion of the magnet; second magnetometers connected to the magnet and arranged at a distance therefrom which is sufficient for the influence of the magnet field not to be perceptible; and means for processing the signals from the first and second magnetometers.

According to an embodiment, the magnet is sleeved with a sleeve made of a magnetic shielding material.

According to an embodiment, wafers made of a magnetic shielding material are arranged on either side of the assembly of first magnetometers.

According to an embodiment, the magnet generates a field which is at least 100 times greater than the Earth's magnetic field.

An embodiment provides a method of analyzing the characteristics of the medium surrounding an unsleeved borehole using a probe such as hereabove, comprising the steps of:

Measuring, for a plurality of same depth positions of the magnetometers, the field collected by the second magnetometers and the field collected by the first magnetometers, and

subtracting the measured fields from each other.

According to an embodiment, the measurements are carried out while the probe is being pulled back up towards the surface.

The foregoing and other features and advantages will be discussed in detail in the following non-limiting description of specific embodiments in connection with the accompanying drawings.

### BRIEF DESCRIPTION OF THE DRAWINGS

FIG. 1A is a cross-section view of an embodiment of a probe in an open hole; and

FIG. 1B is a cross-section view along plane B-B of FIG. 1A.

### DETAILED DESCRIPTION

The present invention is based on a study of the magnetic characteristics of a sedimentary underground medium.

Sedimentary formations contain ferromagnetic elements and paramagnetic elements. The quantity of paramagnetic elements depends on the nature of the sediment, for example, sandstone, clay, or limestone.

The ferromagnetic elements are magnetized (oriented) according to the magnetic field of the time of their deposition. This is what is called NRM (natural remanent magnetization).

The magnetization of the paramagnetic elements is not set and, in the presence of an applied field, they acquire an induced magnetization. These elements are naturally oriented according to the current Earth's magnetic field. Such an ability of the elements to orient corresponds to magnetic susceptibility χ with, vectorially, M=χH, M being the magnetization of the elements and H being the applied field. Magnetic susceptibility χ depends on the nature of the layers and has a significant variation range for the different current sedimentary formations. Thus, it has been determined that magnetic susceptibility χ for example varies between low values in the order of 10-6 for pure limestones up to values in the order of 10-2 for clays. It should be noted that such a variation range of χ, of 4 orders of magnitude, is particularly large. In the case of electric measurements, the conductivity variation range, in Siemens per meter, is of 3 orders of magnitude only, between 10-4 and 10-1. Thus, a magnetic susceptibility measurement enables to determine with more contrast the medium to be analyzed.

χ is thus desired to be measured. Direct measurements of magnetization variations in a hole come against a number of issues. Indeed, the magnetic fields in a hole result on the one hand from the ferromagnetic elements, on the other hand from the paramagnetic elements submitted to the Earth's magnetic field.

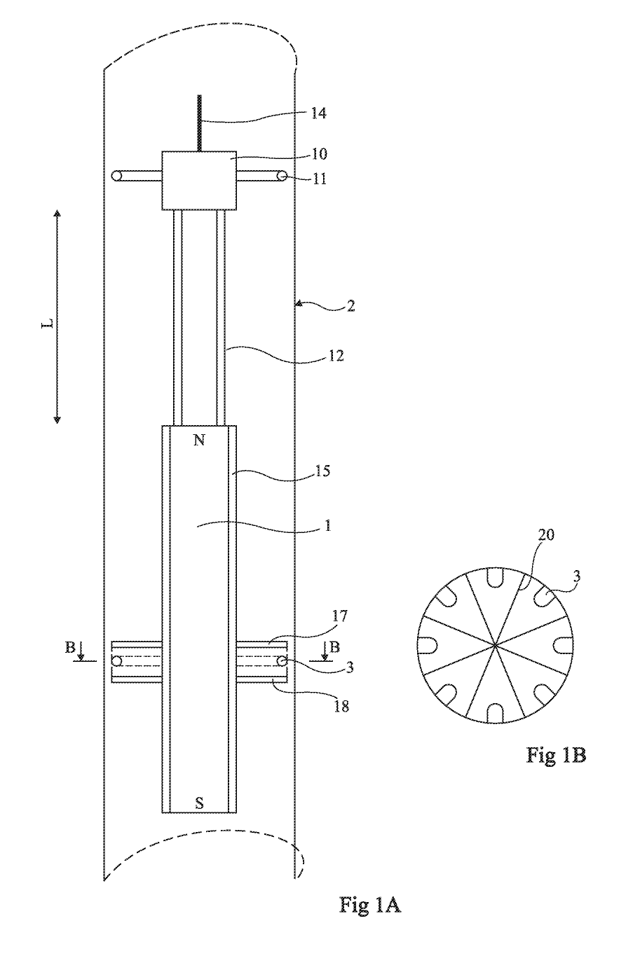

FIG. 1A shows a probe allowing such field measurements and the compensation of parasitic fields.

The probe comprises a magnet 1 of great length (for example, from 15 centimeters to 1 meter) having North and South poles, N and S. Magnet 1 is arranged in the hole (vertical or inclined) and has an outer diameter smaller than the inner diameter of the hole, which is currently in the order of from 15 to 30 centimeters. The magnet, by inducing a field substantially higher than the Earth's magnetic field, provides a double advantage. On the one hand, the induced magnetization that it will generate is much higher than that generated by the Earth's magnetic field, which is then of second order. Thus, the value of the induced magnetization corresponds to the sensitivity of magnetometers available on the market. On the other hand, the magnet will induce a field collinear to the axis of the device, which is not the case for the Earth's magnetic field, which has any direction relative to the device axis. This is a necessary advantage to obtain a regular image of the hole wall. Magnet 1 is surrounded with a ring of magnetometers 3 schematically shown in top view in FIG. 1B. Ring 3 is distant from the ends of magnet 1 and is preferably arranged in a substantially central portion of the magnet. The substantially central portion for example has a height corresponding to half the length of the magnet.

The probe further comprises, at a distance L from the upper pole of the element, a package 10 comprising an assembly of magnetometers 11 distant from magnet 1 by a distance L. Distance L is selected so that, at the level of magnetometers 11, the field generated by magnet 1 is not perceptible, that is, so that it is negligible as compared with the field generated by the magnet in the vicinity of its middle area, preferably at least 0.01 smaller. Package 10 also comprises electronic signal processing and transmission devices. Package 10 is mechanically connected to the magnet, for example, by rods 12. The assembly of magnet 1 and of package 10 is connected to a connection cable 14 ensuring a function of mechanical connection and a function of electric and electronic connection. Cable 14 enables to move the probe up and down and to transmit the signals supplied by the electric and electronic circuits contained in package 10 towards the surface. Cable or electromagnetic connections may be provided between magnetometers 3 and the electronic circuits of package 10.

Magnetometers 3 measure a field Bi1 resulting, at the location where they can be found, from the Earth's magnetic field, from the field created by magnet 1, and from the field supplied by the magnetization of the various surrounding elements contained in the medium surrounding the open hole. Field Bi1 is equal to:

Bi1=Bemf+Biemf+Bnrm+B+Bi,

where:
Bemf designates a component linked to the Earth's magnetic field,
Biemf designates a component corresponding to the magnetization of the paramagnetic elements induced by the Earth's magnetic field,
Bnrm designates a component corresponding to the natural remanent magnetization of the ferromagnetic elements contained in the medium,
B designates a component linked to the field created by magnet 1, and
Bi designates a component corresponding to the magnetization of the paramagnetic elements induced by magnet 1.

Magnetometers 11 analyze the medium which surrounds them without being submitted to the field of magnet 1 and measure a field Bi2 such that:

Bi2=Bemf+Biemf+Bnrm.

In operation, the probe is displaced regularly, continuously, or in stages. For different depths in the hole, the signals collected by magnetometers 11, and then the signals collected at the same depths by magnetometers 3, are determined. The signals are stored and processed, either at the level of device 10 or at the surface.

By subtraction of the measurements of magnetometers 3 and of the measurements of magnetometers 11, for a same depth, a measurement Bi3 is obtained:

Bi3=B+Bi,

where B is a constant corresponding to the direct effect of the field of magnet 1 and where Bi corresponds to magnetization χH, H being the field caused by magnet 1. A way to measure χ is thus obtained, field H of the magnet being constant.

To free as much as possible magnetometers 3 from the direct influence of magnet 1, the magnet is preferably surrounded with a shielding sleeve 15 so that the field lines of the magnet only come out and enter through its North and South poles, N and S. Further, wafers 17 and 18 of a magnetic shielding material may be provided on either side of the assembly of magnetometers 3. The shielding material is for example μ metal or a nanofilm having similar properties. The magnetometers are arranged as close as possible to the hole walls, the magnetometers and wafers 17 and 18 being preferably all mounted on pads to properly slide at a constant distance, preferably smaller than 1 cm, from the hole walls. It should be noted that shielding wafers 17 and 18 may be replaced with compensation coils generating a field capable of compensating the direct field of the magnet.

It should further be noted that the measurements are preferably carried out as the probe comprising magnet 1, magnetometers 3, and measurement assembly 10 arranged at a distance L from the magnet, is being pulled back up. Indeed, when taken down, the probe move down under the effect of its weight and this descent may be chaotic. Conversely, when going up, the probe is pulled by a cable and the rise can be very even.

To form magnet 1 of great length, a magnet in three portions may be provided, comprising a central bar made of soft iron or of an equivalent material and magnets arranged at the two ends of the soft iron bar. A polar part made of soft iron may also be added at each end of the above magnet with the aim of directing the field lines towards the inside of the sedimentary rock to be magnetized.

In practice, it has been determined that, by using a magnet 1 supplying a field substantially 100 times greater than the Earth's magnetic field, it is possible, with current magnetometers, to detect the signals to be measured (the fields generated by the paramagnetic elements) with a sufficient sensitivity and contrast.

The magnetometers may be made more directional by further providing, between the magnetometers, radial partitions 20 visible in FIG. 1B, also made of a shielding material such as μ metal.

The probe is may have a number of variations. In particular, although magnet 1 has been described as being arranged under processing device 10, such a layout may be inverted. Further, the block comprising the second magnetometers may be dissociated from the block comprising the processing and transmit circuits.

A probe for measuring the gamma radiation emitted by the considered medium may be associated with the magnetic susceptibility measurement probe. The gamma radiation emitted by the rocks enable to roughly identify the lithology. Such a gamma radiation measurement probe may be used to correlate together the different physical measurements performed in a drilling. It should also be noted that the correlation/anticorrelation between the gamma radiation and the magnetic susceptibility enables to correlate data relative to holes which are very distant from one another.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

1. A probe for analyzing the characteristics of the medium surrounding an unsleeved borehole comprising:
an elongated magnet (1);
a ring of first magnetometers (3) surrounding a substantially central portion of the magnet;
second magnetometers (11) mechanically linked to the magnet and arranged at a distance therefrom which is sufficient for the influence of the magnet field not to be perceptible; and
means for processing the signals from the first and second magnetometers.

2. The probe of claim 1, wherein the magnet is sleeved with a sleeve (15) made of a magnetic shielding material.

3. The probe of claim 1, wherein wafers (17, 18) made of a magnetic shielding material are arranged on either side of the assembly of first magnetometers (3).

4. The probe of claim 1, wherein the magnet generates a field which is at least 100 times greater than the Earth's magnetic field.

5. A method of analyzing the characteristics of the medium surrounding an unsleeved borehole using the probe of any of claims 1 to 4, comprising the steps of:
measuring, for a plurality of same depth positions of the magnetometers, the field collected by the second magnetometers and the field collected by the first magnetometers, and
subtracting the measured fields from each other.

6. The method of claim 5, wherein the measurements are carried out while the probe is being pulled back up towards the surface.
